(19) United States
(12) Patent Application Publication
(10) Pub. No.: US 2013/0252549 A1
(43) Pub. Date: Sep. 26, 2013

(54) RADIO APPARATUS

(71) Applicants: Koji OGURA, Tokyo (JP); Tsuyoshi KOGAWA, Kawasaki-shi (JP); Takafumi SAKAMOTO, Tokyo (JP)

(72) Inventors: Koji OGURA, Tokyo (JP); Tsuyoshi KOGAWA, Kawasaki-shi (JP); Takafumi SAKAMOTO, Tokyo (JP)

(73) Assignee: KABUSHIKI KAISHA TOSHIBA, Tokyo (JP)

(21) Appl. No.: 13/619,551

(22) Filed: Sep. 14, 2012

Related U.S. Application Data
(63) Continuation of application No. PCT/JP2010/002459, filed on Apr. 2, 2010.

(51) Int. Cl. H04W 52/02

(52) U.S. Cl. CPC H04W 52/0225
USPC 455/41.2

(57) ABSTRACT

According to one embodiment, a radio apparatus configured to communicate with a second radio apparatus after receiving plural first signals transmitted from the second radio apparatus in a constant cycle, the radio apparatus includes: a communication circuit configured to communicate with the second radio apparatus; a wave detection circuit configured to generate a wave detection signal by envelope-detecting the plural first signals; a bandpass filter having an IIR filter, configured to generate a detection signal form the wave detection signal, the detection signal having amplitude is increased at a frequency corresponding to the constant cycle; and a control unit configured to cause supply of power to the communication circuit if the amplitude is larger than a first threshold value.

### CROSS-REFERENCE TO RELATED APPLICATION(S)

This is a Continuation Application of PCT Application No. PCT/JP2010/002459, filed on Apr. 2, 2010, which was published under PCT Article 21 (2) in Japanese, the entire contents of which are incorporated herein by reference.

### FIELD

This disclosure relates to a radio apparatus.

### BACKGROUND ART

In apparatus which perform short-range wireless communication in manners that are standardized by such communication standards as IEEE 802.15.1 and IEEE 802.15.4, the power consumption is reduced by shortening the operation time of a reception circuit by performing intermittent receiving operations. However, where, for example, a call is made by establishing a connection between a cell phone (controlling side) and a headset (controlled side) according to the IEEE 802.15.1 standard, the standby time is very long relative to the call time during which a communication is made between the cell phone and the headset. In this case, there is a problem that the standby power consumption is large even if intermittent receiving operations are performed. In particular, there is demand that the standby power consumption be reduced in controlled-side radio apparatus because it is difficult for them to be equipped with a large battery.

In this connection, a method in which a standby-dedicated wave detector which operates at a much lower power consumption than, for example, radio units that comply with the IEEE 802.15.1 standard is provided in a controlled-side radio apparatus and a controlling-side radio apparatus causes power-on of an IEEE 802.15.1-compliant radio unit of the controlled-side radio apparatus was proposed.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 shows a wireless communication system according to a first embodiment.

FIG. 2 shows example first signals (A), an example wave detection signal (B), and an example detection signal (C).

FIG. 3 shows a second radio apparatus 215 according to a second embodiment.

FIG. 4 shows an example fourth signal.

FIG. 5 shows a second radio apparatus 315 according to a third embodiment.

FIG. 6 shows a second radio apparatus 415 according to a fourth embodiment.

FIG. 7 shows a third bandpass filter 305 used in the fourth embodiment.

FIG. 8 shows a second radio apparatus 515 according to a fifth embodiment.

FIG. 9A shows a frequency characteristic of first signals, and FIG. 9B shows a frequency characteristic of fourth signals.

FIG. 10 shows a second radio apparatus 615 according to a sixth embodiment.

FIG. 11 shows a fifth bandpass filter 505 used in the sixth embodiment.

### DETAILED DESCRIPTION

Embodiments of the present invention will be hereinafter described with reference to the drawings. In the following embodiments, it is assumed that items that are given the same numeral operate in the same manner or similar manners and they will not be described redundantly.

According to one embodiment, a radio apparatus configured to communicate with a second radio apparatus after receiving plural first signals transmitted from the second radio apparatus in a constant cycle, the radio apparatus includes: a communication circuit configured to communicate with the second radio apparatus; a wave detection circuit configured to generate a wave detection signal by envelope-detecting the plural first signals; a bandpass filter having an IIR filter, configured to generate a detection signal from the wave detection signal, the detection signal having amplitude that is increased at a frequency corresponding to the constant cycle; and a control unit configured to cause supply of power to the communication circuit if the amplitude is larger than a first threshold value.

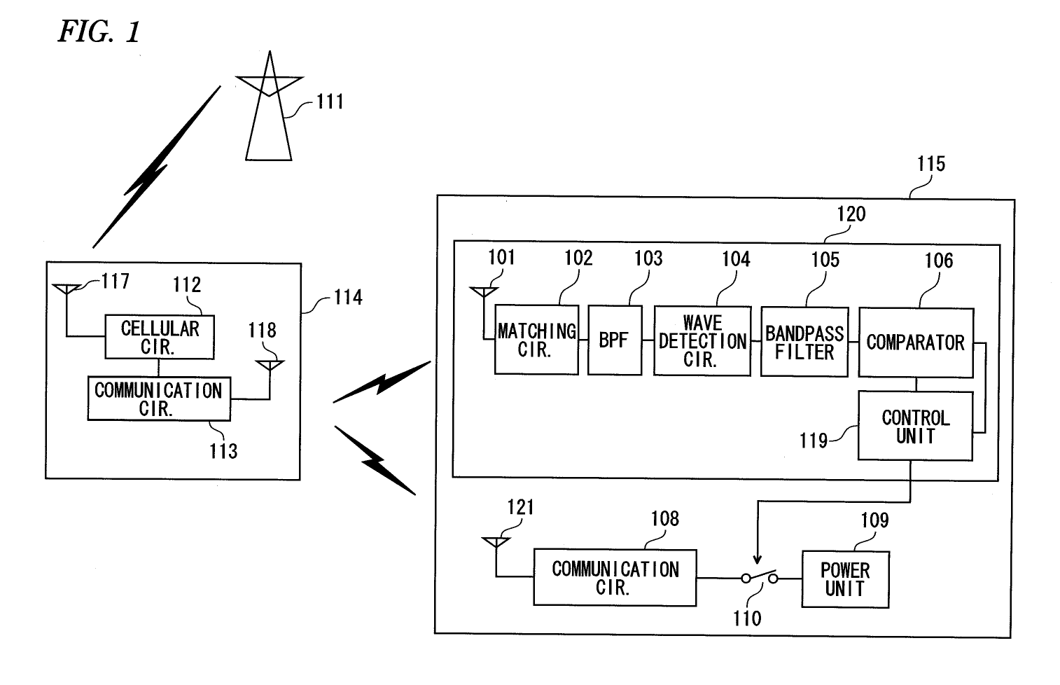

A wireless communication system according to a first embodiment of the invention will be described. FIG. 1 shows an example wireless communication system according to this embodiment. This wireless communication system has a first radio apparatus 114 such as a cell phone (controlling side) and a second radio apparatus 115 such as a headset (controlled side). The second radio apparatus 115 is powered on when receiving a signal that is transmitted from the first radio apparatus 114, and starts communicating with the first radio apparatus 114. In the embodiment, the first radio apparatus 114 which sends out a signal for powering on the second radio apparatus 115 is also called a controlling radio apparatus 114. The second radio apparatus 115 which is powered on by a signal transmitted from the first radio apparatus (controlling radio apparatus) 114 is also called a controlled radio apparatus.

The first radio apparatus 114 also belongs to a cellular system and has a cellular circuit 112 for communicating with a base station 111, for example. The first radio apparatus 114 has a communication circuit 113 for performing, for example, an IEEE 802.15.1-compliant communication with the second radio apparatus 115.

The cellular circuit 112, which has a circuit (not shown) such as a frequency converter for communicating with the base station 111, receives audio data, image data, or the like from the base station 111 via an antenna 117. The cellular circuit 112 passes, to a communication circuit 113, the audio data received from the base station 111. The cellular circuit 112 sends audio data passed from the communication circuit 113 to the base station 111 via the antenna 117. The cellular circuit 112 also sends, to the base station 111, data (e.g., image data) other than audio data passed from the communication circuit 113. The cellular circuit 112 is also called a second communication circuit.

The communication circuit 113, which has a circuit (not shown) such as a frequency converter for communicating with the second radio apparatus 115, receives audio data from second radio apparatus 115 via an antenna 118. The communication circuit 113 passes, to the cellular circuit 112, audio data received from the second radio apparatus 115. The communication circuit 113 sends audio data received from the cellular circuit 112 to the second radio apparatus 115 via the antenna 118.

The communication circuit 113 sends out first signals in a constant cycle. Where the communication circuit 113 is a circuit which performs an IEEE 802.15.1-compliant communication, the communication circuit 113 sends out first signals in a burst-like manner in the cycle corresponding to 800 Hz. The communication circuit 113 sends out plural first signals while doing transmission frequency hopping in order of f0, f6, f2, f9, . . . .

Next, the configuration of the second radio apparatus 115 will be described. The second radio apparatus 115 is equipped with a receiving circuit 120, a communication circuit 108 which performs, for example, an IEEE 802.15.1-compliant communication, a power circuit 109 which supplies power to the communication circuit 108, and a switch 110 which makes switching as to whether to allow supply of power to the communication circuit 108 from the power unit 109 according to an instruction from the receiving circuit 120.

The receiving circuit 120 is equipped with a wave detection circuit 104 which envelope-detects a first signal and thereby generates a wave detection signal, a bandpass filter 105 which generates a detection signal from the wave detection signal, the detection signal having amplitude that is increased at the frequency corresponding to the constant cycle, a comparator 106 which compares the amplitude of the detection signal with a threshold value, and a control unit 109 which causes supply of power to the communication circuit 108 if the amplitude of the detection signal is larger than the threshold value. The receiving circuit 120 is also equipped with an antenna 101, a matching circuit 102, a first bandpass filter 103, and a wave detection circuit 104.

The receiving circuit 120 will be described in detail.

The antenna 101 receives a first signal transmitted from the communication circuit 113. The matching circuit 102 is a circuit for matching between the output impedance of the antenna 101 and the input impedance of the first bandpass filter 103. The first bandpass filter 103 suppresses out-of-band signals contained in the first signal received by the antenna 101 and thereby generates a first signal in a desired band. The first bandpass filter 103 is a filter having, as pass-bands, plural bands of frequency hopping. For example, where first signals are transmitted with frequency hopping between frequencies f0 and f9 in order of f0, f6, f2, f9, the first bandpass filter 103 has, as pass-bands, frequency bands which are in the range of f0 to f9.

The wave detection circuit 104 wave-detects the first detects the first signal in the desired band generated by the first bandpass filter 103. For example, the wave detection circuit 104 has a rectifier and a comparator (not shown). The wave detection circuit 104 envelope-detects the signal detected by the antenna 101 and thereby generates a wave detection signal.

The bandpass filter 105, which has a second-order IIR filter (not shown), generates a detection signal from the wave detection signal, the detection signal having amplitude that is increased at the frequency corresponding to the constant cycle. The pass-band of the bandpass filter 105 includes the frequency corresponding to the constant cycle. Where the communication circuit 113 is a circuit which performs an IEEE 802.15.1-compliant communication, since the communication circuit 113 sends out first signals in a burst-like manner in the cycle corresponding to 800 Hz, the bandpass filter 105 extracts an 800-Hz signal. The bandpass filter 105 is a filter having a narrower band than the first bandpass filter 103.

The comparator 106 compares the detection signal with a threshold value. If the detection signal is larger than the threshold value, the comparator 106 generates a power control signal. When receiving the power control signal, the control unit 119 controls the switch 110 so that power is supplied to the communication circuit 108 from the power unit 109.

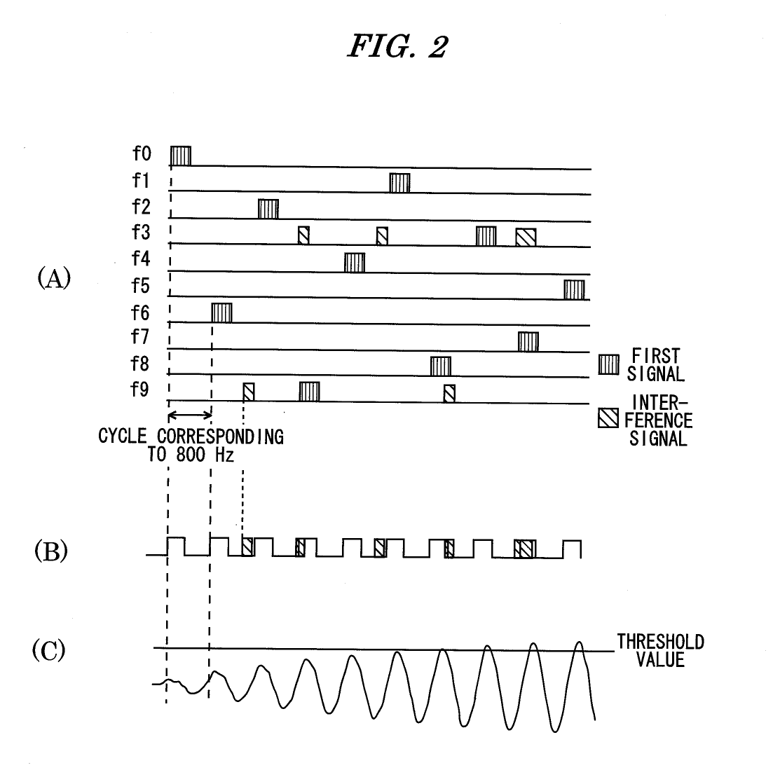

Next, how the receiving circuit 120 operates will be described with reference to FIG. 2.

FIG. 2(A) show example signals which are received by the antenna 101. As shown in FIG. 2(A), the first radio apparatus 114 sends out first signals while doing frequency hopping in order of f0, f6, f2, f9, . . . in the cycle corresponding to 800 Hz. For example, if the frequency bands (f0-f9) in which the first radio apparatus 114 sends out first signals are parts of an ISM band, wireless LAN signals may be received by the antenna 101 as interference signals. The antenna 101 passes the received first signals and interference signals to the wave detection circuit 104 via the matching circuit 102 and the first bandpass filter 103.

The wave detection circuit 104 generates a wave detection signal containing low signals and high signals (see FIG. 2(B)) on the basis of the first signals and the interference signals. The wave detection circuit 104 outputs a high signal when receiving a first signal or an interference signal. When receiving neither a first signal nor an interference signal, the wave detection circuit 104 outputs a low signal.

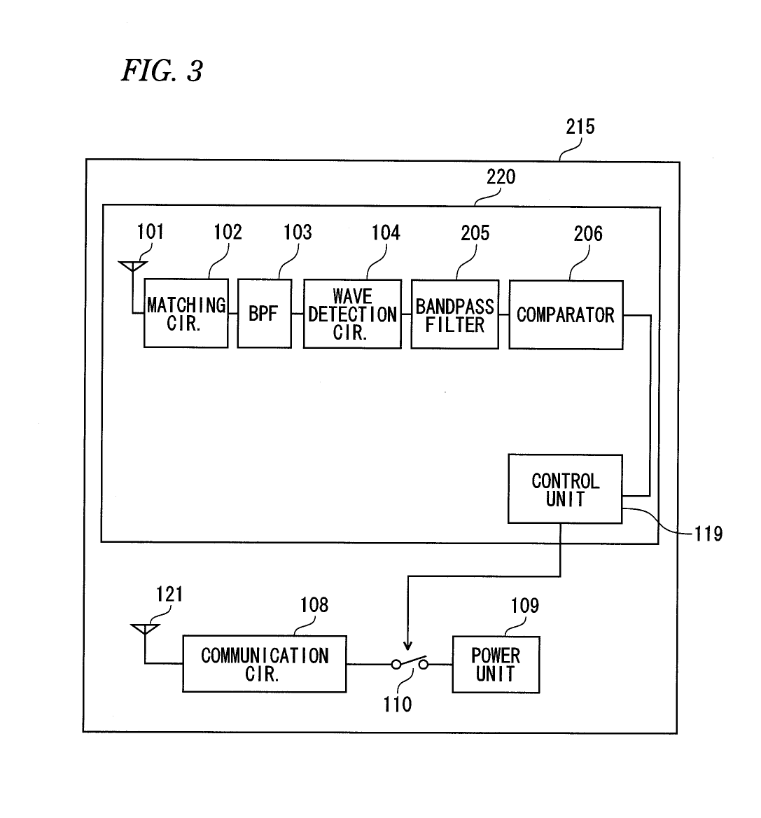

The wave detection signal containing the low signals and the high signals is input to the bandpass filter 105. In the bandpass filter 105, the wave detection signal is converted into a detection signal in which signals other than the 800-Hz signal are suppressed. FIG. 3(C) shows an example detection signal. The amplitude of the detection signal is increased at 800 Hz. Since the wave detection circuit 104 generates a wave detection signal by performing envelope detection without discriminating between first signals and interference signals, the wave detection signal becomes a high signal if an interference signal exists. However, in the embodiment, the bandpass filter 105 averages first signals having the desired frequency (800 Hz) over a prescribed period and outputs a resulting signal. Since interference signals which have no periodicity are suppressed by the bandpass filter 105, the amplitude of the detection signal is increased at the desired frequency. Even if interference signals are periodic, if their cycle is different from the desired cycle (corresponds to 800 Hz), they are out of the pass-band of the bandpass filter 105 and hence are suppressed by the bandpass filter 105. This is because the bandpass filter 105 is a narrow-band filter and stops signals whose frequencies are different from the desired frequency. In this manner, the detection signal is made a signal having amplitude that is increased at the desired frequency.

If the amplitude of the detection signal becomes larger than the threshold value, the comparator outputs a power control signal. Receiving the power control signal, the control unit 119 controls the switch 110. An alternative configuration is possible in which the control unit 119 is integral with the comparator 106 and the switch receives a power control signal directly. In this case, the switch 110 operates so as to supply power to the communication circuit 108 when receiving a power control signal.

As described above, in the wireless communication system according to the embodiment, the communication circuit 108 is activated when first signals having a constant cycle which are transmitted from the communication circuit 113 are detected by the receiving circuit 120. Therefore, the first radio apparatus 114 need not be equipped with a circuit that is dedicated to activation of the communication circuit 108. Furthermore, the communication circuit 108 can operate while the first radio apparatus 114 is sending out first signals. Therefore, the power consumption of the second radio apparatus 115 can be reduced without increasing the circuit scale of the first radio apparatus 114 (controlled side).

Although in the embodiment the second-order IIF filter is used in the bandpass filter 105, the same advantages can also be obtained by using an even higher order IIF filter. However, the use of the second-order IIR filter can suppress increase in circuit scale because it is smaller in circuit scale than even higher order IIF filters.

### (Modification 1)

Whereas the above-described first embodiment is directed to the case that the communication circuits 113 and 108 of the first radio apparatus 114 and the second radio apparatus 115 perform an IEEE 802.15.1-compliant communication, they may perform a wireless LAN communication. A description will be made of a case that the first radio apparatus 114 is an access point and the second radio apparatus 115 is a station. In this case, beacon signals, for example, can be used as first signals.

General access points sends out beacon signals in a cycle of 102.4 ms. In this case, the bandpass filter 105 generates a detection signal having amplitude that is increased in a cycle of 102.4 ms. As a result, the second radio apparatus 115 can activate the communication circuit 108 only in the case where it is located within the communication range of the first radio apparatus 114 which is the access point.

The transmission interval of beacon signals can be switched between plural values. Where the communication ranges of plural access points overlap with each other, the beacon signal transmission intervals of adjoining access points are made different from each other. This allows the communication circuit 108 to be activated only in the case where the second radio apparatus 115 is located in the communication range of a particular access point. For example, even in a case that an access point which is sending out beacon signals in a cycle of 102.4 ms exists near a home, it is possible to activate the communication circuit 108 of the second radio apparatus 115 only when it is located in the operation range of an access point installed in the home by setting the beacon signal transmission interval of the home access point to 70 ms.

### (Modification 2)

Whereas in the first modification the second radio apparatus 115 is a station, the first radio apparatus 114 and the second radio apparatus 115 can be made a station and an access point, respectively. Whereas access points send out a beacon signal regularly, stations do not. In view of this, in this modification, the first radio apparatus 114 sends out first signals with such timing that the communication circuit 113 is activated. For example, active scan probe signals can be used as first signals.

When receiving probe signals, the second radio apparatus 115 activates the communication circuit 108 and starts a communication with the communication circuit 113 of the first radio apparatus 114. On the other hand, if a communication with the communication circuit 108 is not started even if probe signals have been sent out for a prescribed period, the first radio apparatus 114 suspends the transmission of probe signals. The first radio apparatus 114 may restart transmission of probe signals after a lapse of a prescribed period from the suspension of transmission of probe signals.

A case that operation of the first radio apparatus 114 has been stopped will be considered. Where the first radio apparatus 114 is a notebook PC, this is a case that the notebook PC has been powered off. When instructed to power itself off, the first radio apparatus 114 instructs the second radio apparatus 115 to stop operation of the communication circuit 108. This may be done by the communication circuit 113 by accessing the communication circuit 108 using a wireless LAN communication. After instructing the second radio apparatus 115 to stop operation of the communication circuit 108, the first radio apparatus 114 powers itself off. The second radio apparatus 115 controls the switch 110 so that the supply of power to the communication circuit 108 is stopped.

Next, a wireless communication system according to a second embodiment of the invention will be described with reference to FIG. 3. In the wireless communication system according to this embodiment, the configuration of the first radio apparatus 114 is the same as shown in FIG. 1 and hence will not be described. The first radio apparatus 114 sends out a fourth signal which contains a second signal and a third signal which is sent so as to have a constant interval from the second signal. For example, where the communication circuit 113 is a circuit that performs an IEEE 802.15.1-compliant communication, the fourth signal corresponds to an inquiry scan signal or a page scan signal. In this case, the constant interval is 312.5 μs and the constant cycle is 1.250 ms. The fourth signal will be described later in detail. A second radio apparatus 215 activates the communication circuit 108 when receiving a fourth signal.

The second radio apparatus 215 has a second bandpass filter 205 and a second comparator 206 in place of the bandpass filter 105 and the comparator 106 of the receiving circuit 120 of the second radio apparatus 115 shown in FIG. 1.

The second bandpass filter 205, which has a second-order IIR filter (not shown), generates a second detection signal from a wave detection signal, the second detection signal having amplitude that is increased at a frequency corresponding to the constant interval. The pass-band of the second bandpass filter 205 includes the frequency corresponding to the constant interval. Where the communication circuit is a circuit that performs an IEEE 802.15.1-compliant communication, the frequency corresponding to the constant cycle (312.5 μs) between the second signal and the third signal is 3.2 kHz. Therefore, the second bandpass filter 205 extracts a 3.2-kHz signal. The second bandpass filter 205 is a filter having a narrower band than the first bandpass filter 103.

The second comparator 206 compares the second detection signal with a second threshold value. If the second detection signal is larger than the second threshold value, the second comparator 206 generates a second power control signal.

When receiving the second power control signal, the control unit 119 controls the switch 110 so that power is supplied to the communication circuit 108 from the power unit 109.

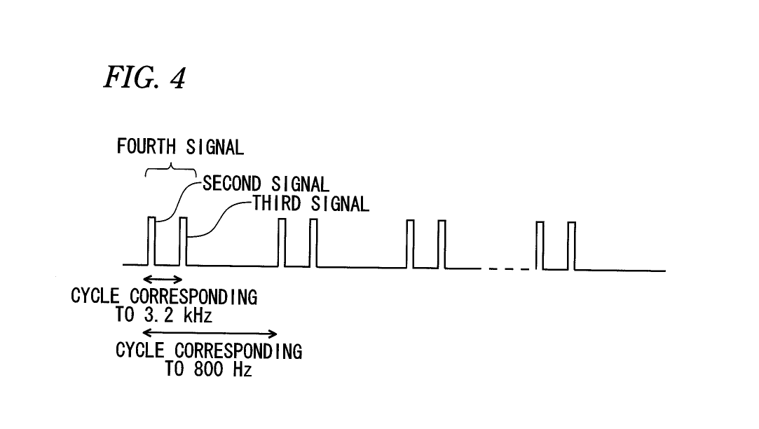

Next, how a receiving circuit 220 operates will be described with reference to FIG. 4.

FIG. 4 shows an example signal which is received by the antenna 101. The first radio apparatus 114 sends out a fourth signal in a burst-like manner. The fourth signal contains a second signal and a third signal which are separated from each other by a constant interval. In the case of an IEEE 802.15.1-compliant communication, the second signal and the third signal are separated from each other by 312.5 μs which corresponds to 3.2 kHz. The first radio apparatus 114 sends out the fourth signal plural times in a cycle of 1.250 ms which corresponds to 800 Hz. The fourth signal may be sent out with frequency hopping in the same manner as the second signals shown in FIG. 2 (A). The antenna 101 passes the received fourth signals to the wave detection circuit 104 via the matching circuit and the first bandpass filter 103. The wave detection circuit 104 generates, on the basis of the fourth signals, a wave detection signal which contains low signals and high signals. The description of this embodiment is directed to a case without interference signals. Therefore, the wave detection signal generated by the wave detection circuit 104 has the same waveform as shown in FIG. 4. The wave detection circuit 104 passes the generated wave detection signal to the second bandpass filter 205.

In the second bandpass filter 205, the detection signal is converted into a second detection signal in which signals other than the 3.2-kHz signal are suppressed. The second detection signal is a signal having amplitude that is increased at 3.2 kHz. The second detection signal is input to the second comparator 206. If the amplitude of the second detection signal becomes larger than the second threshold value, the second comparator 206 passes a second power control signal to the control unit 119.

Receiving the second power control signal, the control unit 119 controls the switch 110. An alternative configuration is possible in which the control unit 119 is omitted and the switch 110 receives a second power control signal directly. In this case, the switch 110 operates so as to supply power to the communication circuit 108 when receiving a second power control signal.

As described above, in the wireless communication system according to the embodiment, the same advantages as provided by the first embodiment are provided. Furthermore, the communication circuit 108 can be activated when such a signal as an inquiry scan signal or a page scan signal of the IEEE 802.15.1 standard is received.

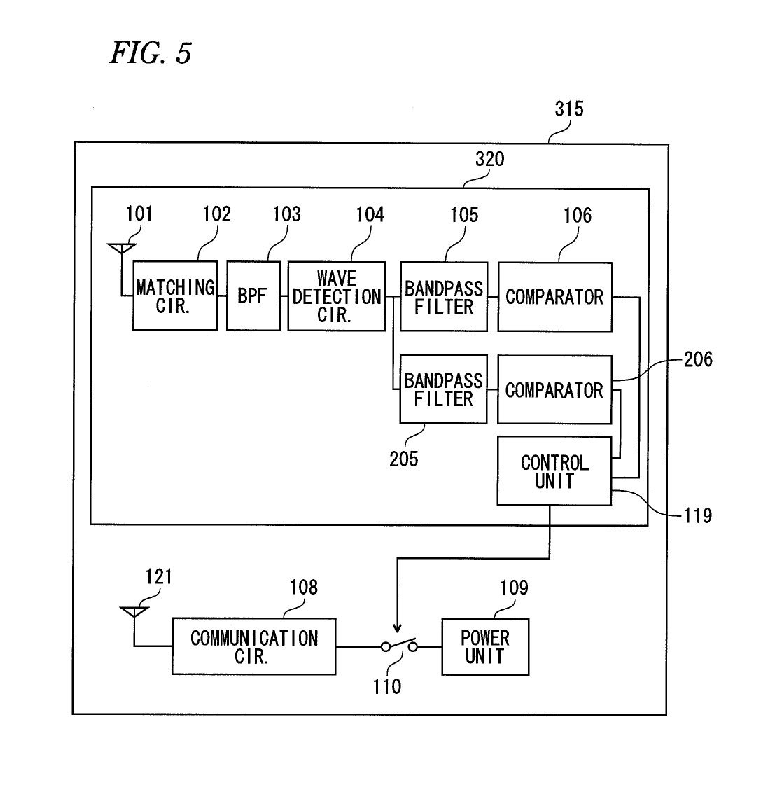

Next, a wireless communication system according to a third embodiment of the invention will be described with reference to FIG. 5. In the wireless communication system according to this embodiment, the configuration of the first radio apparatus 114 is the same as shown in FIG. 1 and hence will not be described. The first radio apparatus 114 sends out a fourth signal which contains a second signal and a third signal which is sent so as to have a constant interval from the second signal. For example, where the communication circuit 113 is a circuit that performs an IEEE 802.15.1-compliant communication, the fourth signal corresponds to an inquiry scan signal or a page scan signal. In this case, the constant interval is 312.5 μs and the constant cycle is 1.250 ms. The fourth signal will be described later in detail. A second radio apparatus 215 activates the communication circuit 108 when receiving a fourth signal.

The second radio apparatus 315 has the bandpass filter 105 and the comparator 106 of the receiving circuit 120 of the second radio apparatus 115 shown in FIG. 1 and the second bandpass filter 205 and the second comparator 206 shown in FIG. 3. The individual constituent elements are the same as shown in FIGS. 1 and 3 and hence will not be described.

How a receiving circuit 320 of the second radio apparatus 315 operates will be described.

The first radio apparatus 114 sends out a fourth signal in a burst-like manner. The fourth signal contains a second signal and a third signal which are separated from each other by a constant interval. In the case of an IEEE 802.15.1-compliant communication, the second signal and the third signal are separated from each other by 312.5 μs which corresponds to 3.2 kHz. The first radio apparatus 114 sends out the fourth signal plural times in a cycle of 1.250 ms which corresponds to 800 Hz. The fourth signal may be sent out with frequency hopping in the same manner as the second signals shown in FIG. 2 (A). The antenna 101 passes the received fourth signals to the wave detection circuit 104 via the matching circuit and the first bandpass filter 103. The wave detection circuit 104 generates, on the basis of the fourth signals, a wave detection signal which contains low signals and high signals. The description of this embodiment is directed to a case without interference signals. Therefore, the wave detection signal generated by the wave detection circuit 104 has the same waveform as shown in FIG. 4. The wave detection circuit 104 passes the generated wave detection signal to the band-pass filter 104 and the second bandpass filter 205.

In the bandpass filter 105, the wave detection signal is converted into a detection signal in which signals other than the 800-Hz signal are suppressed. The detection signal is a signal having amplitude that is increased—at 800 Hz. The detection signal is input to the comparator 106. If the amplitude of the detection signal becomes larger than the threshold value, the comparator 106 passes a power control signal to the control unit 119.

In the second bandpass filter 205, the detection signal is converted into a second detection signal in which signals other than the 3.2-kHz signal are suppressed. The second detection signal is a signal having amplitude that is increased at 3.2 kHz. The second detection signal is input to the second comparator 206. If the amplitude of the second detection signal becomes larger than the second threshold value, the second comparator 206 passes a second power control signal to the control unit 119.

Receiving the power control signal and the second power control signal, the control unit 119 controls the switch 110. An alternative configuration is possible in which the control unit 119 is omitted and the switch 110 receives a power control signal and a second power control signal directly. In this case, the switch 110 operates so as to supply power to the communication circuit 108 when receiving a power control signal or a second power control signal.

As described above, in the wireless communication system according to the embodiment, the same advantages as provided by the first embodiment are provided. Furthermore, the communication circuit 108 can be activated when such a signal as an inquiry scan signal or a page scan signal of the IEEE 802.15.1 standard is received.

Since the control unit 119 controls the switch 110 when receiving both of a power control signal and a second power control signal, an event that the communication circuit 108 of the second radio apparatus 315 is activated undesirably can be prevented. Where an apparatus which performs an IEEE 802.15.1-compliant communication exists near the second radio apparatus 115 in addition to the first radio apparatus 114, the second radio apparatus 115 may receive a signal having a cycle corresponding to 800 Hz that is transmitted from that apparatus.

In view of the above, the control unit 119 controls the switch 110 when receiving both of an activation signal and a second power control signal. This makes it possible to prevent activation of the communication circuit 108 of the second radio apparatus 115 unless fourth signals are received even if, for example, an apparatus which is making a communication using first signals as used in the first embodiment exists near the second radio apparatus 115. The fourth signal is a signal that is sent from the first radio apparatus 114 at the start of a communication, such as an inquiry scan signal or a page scan signal. Therefore, the communication circuit 108 of the second radio apparatus 315 can be activated only when the first radio apparatus 115 starts a communication.

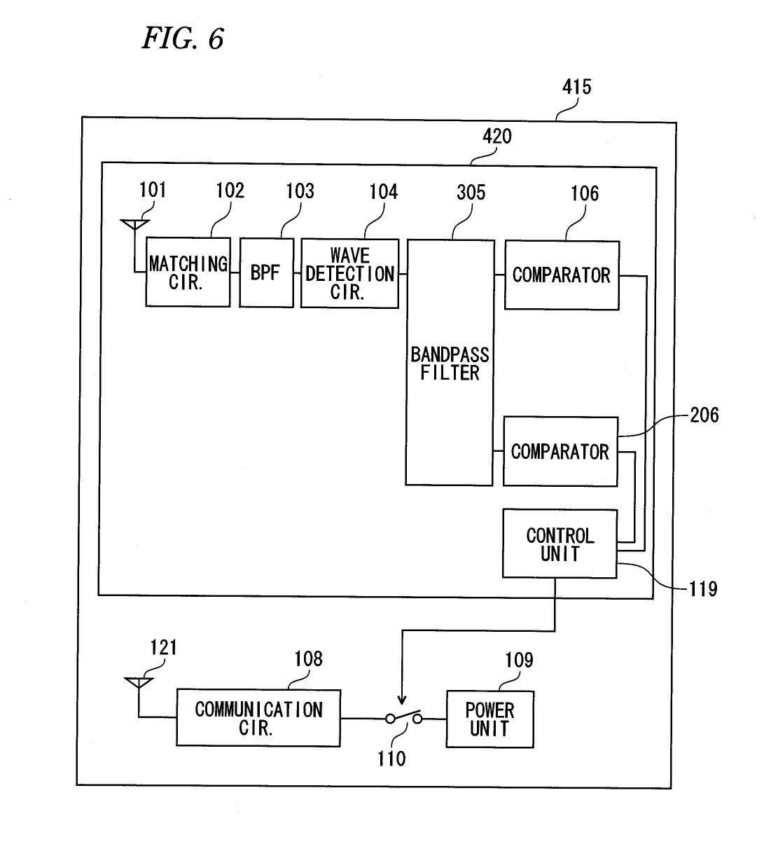

A wireless communication system according to a fourth embodiment of the invention will be described with reference to FIG. 6. In the wireless communication system according to this embodiment, the first radio apparatus 114 is the same in configuration and operates in the same manner as the first radio apparatus 114 according to the third embodiment. A second radio apparatus 415 has a third bandpass filter 305 in place of the bandpass filter 105 and the second bandpass filter 205 shown in FIG. 5. The second radio apparatus 415 has a third comparator 306 in place of the comparator 106.

The third bandpass filter 305, which has a fourth-order IIR filter, generates a second detection signal having amplitude that is increased at 3.2 kHz and a third detection signal having amplitude that is increased at 800 Hz and 3.2 kHz when receiving a wave detection signal.

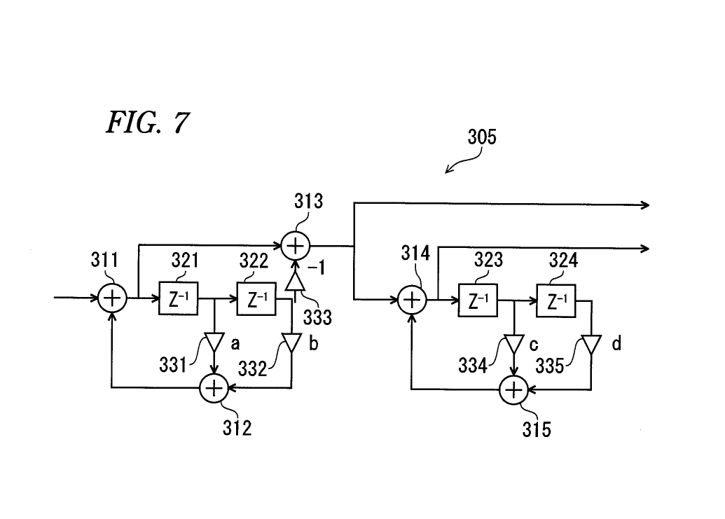

An example bandpass filter 305 will be described with reference to FIG. 7. Having two, cascade-connected second-order IIR filters, the third bandpass filter 305 generates a second detection signal and a third detection signal. More specifically, the third bandpass filter 305 has first to fifth adders 311-315, first to fourth registers 321-324, and first to fifth amplifiers 331-335.

The first adder 311 generates a first addition signal by adding a wave detection signal and a second addition signal (described later) together. The first register 321 holds a one-clock portion of the first addition signal according to a clock signal (not shown) and outputs the currently held one-clock portion of the first addition signal as a first delay signal when receiving the next clock pulse. The first amplifier 331 generates a first amplification signal by amplifying the first delay signal by a factor of a.

The second register 322 holds a one-clock portion of the first delay signal according to the clock signal (not shown) and outputs the currently held one-clock portion of the first delay signal as a second delay signal when receiving the next clock pulse. The second amplifier 331 generates a second amplification signal by amplifying the second delay signal by a factor of b.

The second adder 312 generates a second addition signal by adding first amplification signal and the second amplification signal together.

The third amplifier 333 generates a third amplification signal by multiplying the second delay signal by −1. The third adder 313 generates a third addition signal by adding the first addition signal and the third amplification signal together. The third addition signal is a signal having amplitude that is increased at 3.2 kHz, and is output from the third bandpass filter 305 as a second detection signal.

The fourth adder 314 generates a fourth addition signal by adding the third addition signal and a fifth addition signal together. The fourth register 324 holds a one-clock portion of the fourth addition signal according to the clock signal (not shown) and outputs the currently held one-clock portion of the fourth addition signal as a fourth delay signal when receiving the next clock pulse. The fourth amplifier 334 generates a fourth amplification signal by amplifying the fourth delay signal by a factor of c.

The fifth register 325 holds a one-clock portion of the fourth delay signal according to the clock signal (not shown) and outputs the currently held one-clock portion of the fourth delay signal as a fifth delay signal when receiving the next clock pulse. The fifth amplifier 335 generates a fifth amplification signal by amplifying the fifth delay signal by a factor of d. The fifth adder 315 generates a fifth addition signal by adding the fourth amplification signal and the fifth amplification signal together. The fourth addition signal which is generating the third addition signal and the fifth addition signal together is a signal having amplitude that is increased at 800 Hz and 3.2 kHz, and is output from the third bandpass filter 305 as a third detection signal.

The second comparator 206 compares the second detection signal with a second threshold value, and generates a second power control signal if the second detection signal is larger than the second threshold value. The third comparator 306 compares the third detection signal with a third threshold value, and generates a third power control signal if the third detection signal is larger than the third threshold value. When receiving the second power control signal and the third power control signal, the control unit 119 controls the switch 110 so that power is supplied to the communication circuit 108. Since the third detection signal has energy that is an addition of the energy of the 800-Hz signal and that of the 3.2-kHz signal, it is made higher in noise resistance than an output of a second-order IIR filter. Therefore, the third threshold value may be set larger than the second threshold value.

As described above, in the wireless communication system according to the embodiment, the same advantages as provided by the third embodiment are provided. Furthermore, using an output of a fourth-order IIR filer as a detection signal increases the noise resistance and hence the detection accuracy of fourth signals.

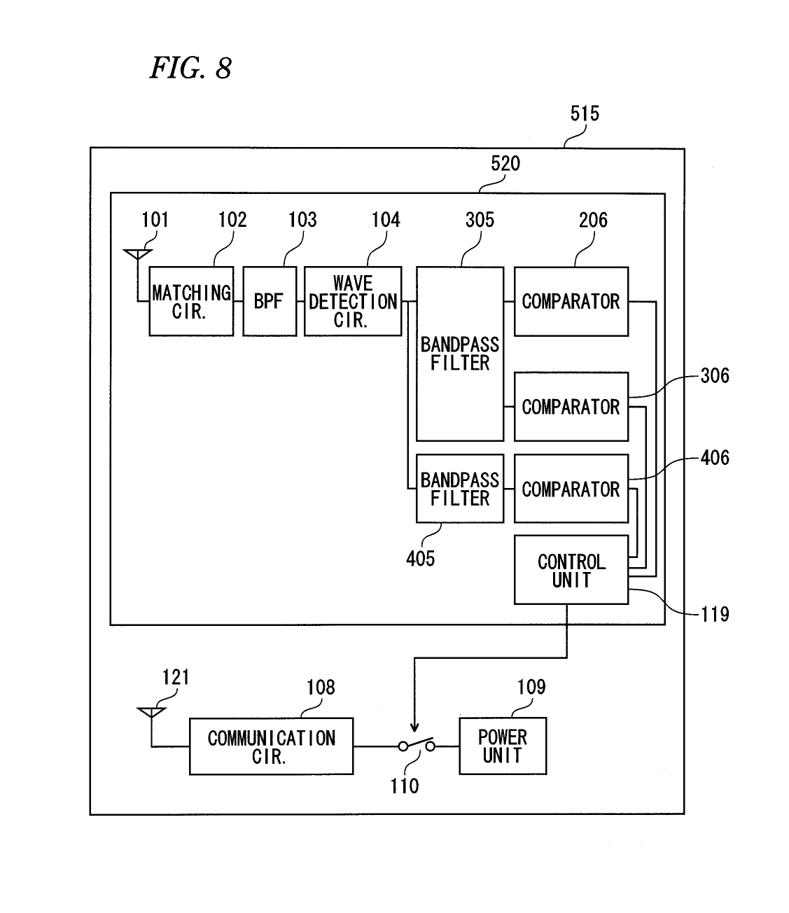

A wireless communication system according to a fifth embodiment of the invention will be described with reference to FIG. 8. In the wireless communication system according to this embodiment, the first radio apparatus 114 is the same in configuration and operates in the same manner as the first radio apparatus 114 according to the third embodiment. A second radio apparatus 515 is equipped with a fourth bandpass filter 405 and a fourth comparator 406 in addition to the configuration of the second radio apparatus 415 shown in FIG. 6.

The fourth bandpass filter 405, which has a second-order IIR filter, generates a fourth detection signal having amplitude that is increased at 1.6 kHz. The fourth comparator 406 compares the fourth detection signal with a fourth threshold value, and generates a stop signal if the fourth detection signal is larger than the fourth threshold value.

The control unit 119 controls the switch 110 so that power is supplied to the communication circuit 108 if it has received a second power control signal and a third control signal and has not received a stop signal. The control unit 119 does not control the switch 110 if it receives a stop signal in addition to a second power control signal and a third power control signal. That is, the control unit 119 controls the switch 110 if the second detection signal is larger than the second threshold value, the third detection signal is larger than the third threshold value, and the fourth detection signal is smaller than or equal to the third threshold value.

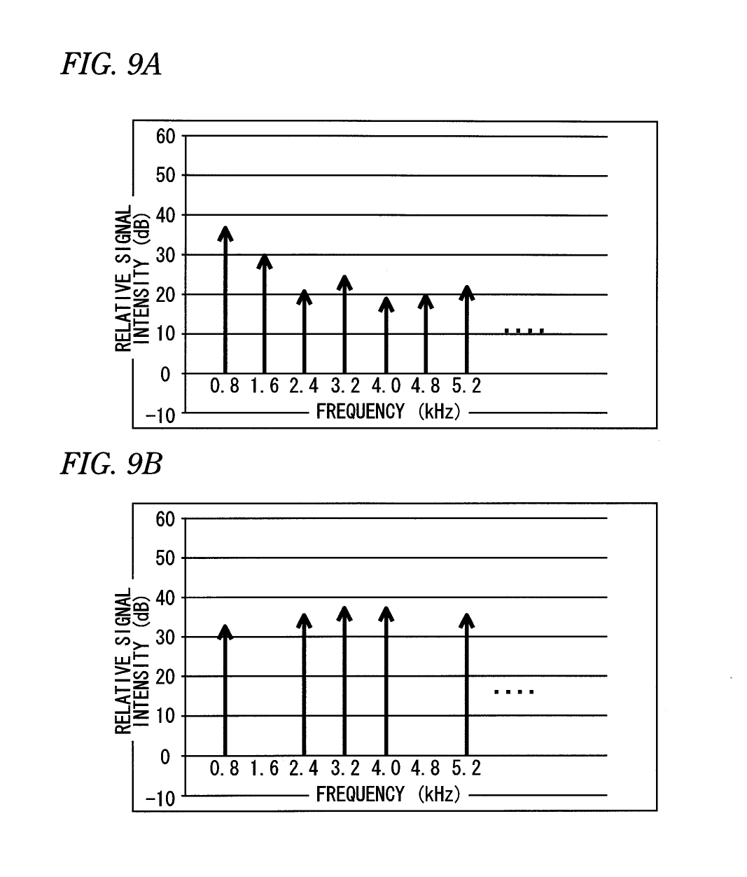

FIG. 9A shows a frequency characteristic of first signals and FIG. 9B shows a frequency characteristic of fourth signals. As shown in FIG. 9A, although the relative power of the main frequency component (0.8 kHz) of the first signals is high, they include frequency components of 1.6 kHz (second harmonic of 0.8 kHz) and 3.2 kHz (fourth harmonic of 0.8 kHz).

On the other hand, as shown in FIG. 9B, the fourth signals have large main frequency components (0.8 kHz and 3.2 kHz) and also have large frequency components of 2.4 kHz and 4.0 kHz. However, the fourth signals include almost no frequency component of 1.6 kHz.

Therefore, the communication circuit 108 is not activated if a 1.6-kHz signal is detected even if a 0.8-kHz signal and a 3.2-kHz are detected.

As described above, in the wireless communication system according to the embodiment, the same advantages as provided by the third embodiment are provided. Furthermore, since the switch 110 is not controlled if a fourth detection signal having amplitude that is increased in a cycle corresponding to 1.6 kHz is detected, the detection accuracy of fourth signals can be increased. Thus, the communication circuit 108 of the second radio apparatus 515 can be prevented from being activated undesirably even if a radio apparatus which is making a communication using first signals exists near the second radio apparatus 515.

Although in the embodiment the fourth bandpass filter 405 and the fourth comparator 406 are additionally provided in the second radio apparatus 415 according to the fourth embodiment, the fourth bandpass filter 405 and the fourth comparator 406 may be provided additionally in the second radio apparatus 215 according to the second embodiment or the second radio apparatus 315 according to the third embodiment.

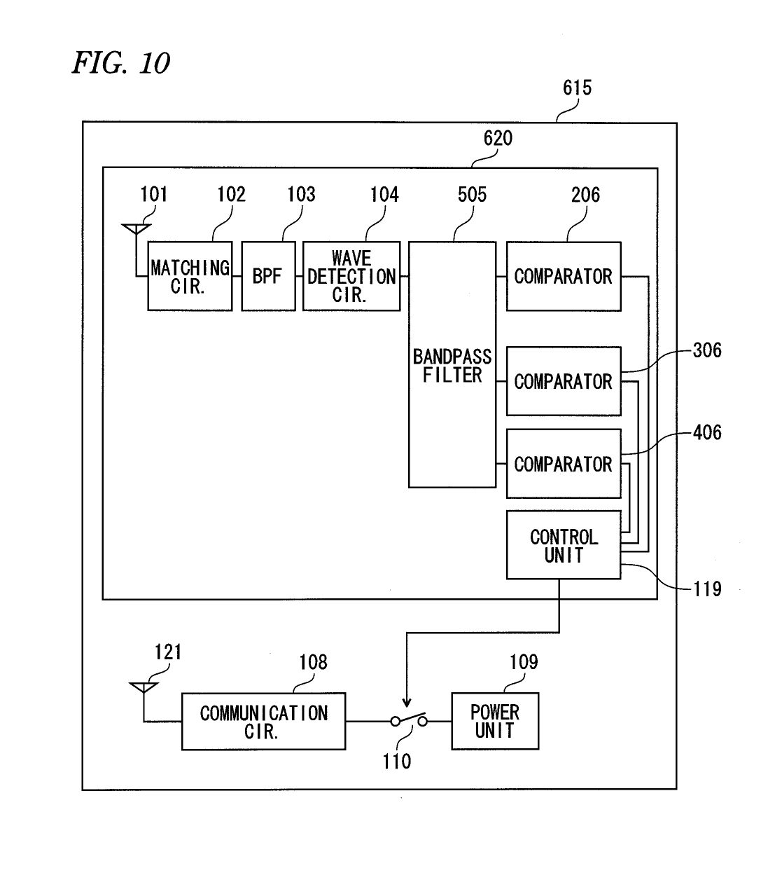

A wireless communication system according to a sixth embodiment of the invention will be described with reference to FIG. 10. In the wireless communication system according to this embodiment, the first radio apparatus 114 is the same in configuration and operates in the same manner as the first radio apparatus 114 according to the third embodiment. A second radio apparatus 615 has a fifth bandwidth filter 505 in place of the third bandpass filter 305 and the fourth bandpass filter 405 of the second radio apparatus 515 shown in FIG. 8. The fifth bandwidth filter 505 operates according to the clock signal and a second clock signal. The fifth bandwidth filter 505 generates a second detection signal having amplitude that is increased at 3.2 kHz and a third detection signal having amplitude that is increased at 800 Hz and 3.2 kHz, or a fourth detection signal having amplitude that is increased at 1.6 kHz.

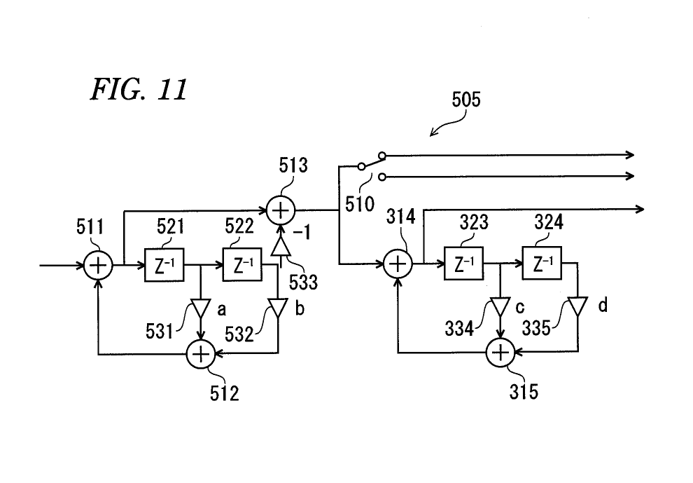

An example fifth bandpass filter 505 will be described with reference to FIG. 11. The fifth bandpass filter 505 is configured in such a manner that a switch 510 is added to the third bandpass filter 305 shown in FIG. 7. The fifth bandpass filter 505 has first to third adders 511-513 in place of the first to third adders 311-313, has first and second registers 521 and 522 in place of the first and second registers 321 and 322, and has first to third amplifiers 531-533 in place of the first to third amplifiers 331-333.

The first and second registers 521 and 522 operate according to the clock signal or the second clock signal whose rate is two times the rate of the clock signal. Where the first and second registers 521 and 522 operate according to the clock signal, the first to third adders 511-513, the first and second registers 521 and 522, and the first to third amplifiers 531-533 are the same in configuration and operate in the same manners as the first to third adders 311-313, the first and second registers 321 and 322, and the first to third amplifiers 331-333 and hence will not be described. Where the first and second registers 521 and 522 operate according to the second clock signal, the switch 510 operates so as to connect the third adder 313 to the second comparator 206. As a result, the fifth bandpass filter 505 generates a second detection signal and a third detection signal as in the case of FIG. 7.

A description will be made of how the fifth bandpass filter 505 operates in the case where the first and second registers 521 and 522 operate according to the second clock signal.

The first adder 511 generates a (1-2) th addition signal by adding a wave detection signal and a (2-2)th addition signal (described later) together. The first register 521 holds a one-clock portion of the (1-2)th addition signal according to the second clock signal (not shown) and outputs the currently held one-clock portion of the (1-2) th addition signal as a (1-2) th delay signal when receiving the next clock pulse. The first amplifier 531 generates a (1-2) th amplification signal by amplifying the (1-2)th delay signal by a factor of a.

The second register 522 holds a one-clock portion of the (1-2)th delay signal according to the second clock signal (not shown) and outputs the currently held one-clock portion of the (1-2)th delay signal as a (2-2)th delay signal when receiving the next clock pulse. The (2-2) th amplifier 532 generates a (2-2)th amplification signal by amplifying the (2-2)th delay signal by a factor of b.

The second adder 512 generates a (2-2) th addition signal by adding (1-2)th amplification signal and the (2-2)th amplification signal together.

The third amplifier 533 generates a (3-2) th amplification signal by multiplying the (2-2) th delay signal by −1. The third adder 513 generates a (3-2) th addition signal by adding the (1-2) th addition signal and the (3-2)th amplification signal together. The (3-2)th addition signal is a signal having amplitude that is increased at 1.6 kHz, and is output from the fifth bandpass filter 505 as a fourth detection signal.

The switch 510 connects the third adder 513 to one of the second comparator 206 and the fourth comparator 406 according to an instruction from the control unit 119, for example.

The control unit 119 controls the switch 510 so that the third adder 513 is connected to the second comparator 206 or the fourth comparator 406.

A description will be made of how a receiving circuit 620 of the second radio apparatus 515 according to the embodiment operates.

First, in a standby state, the control unit 119 of the receiving circuit 620 controls the switch 510 so that the third adder 513 is connected to the second comparator 206. An operation that is performed to generation of a second power control signal and a third power control signal by the second comparator 206 and the third comparator 306, respectively, is the same as in the receiving circuit 420 shown in FIG. 6, and hence will not be described.

When receiving the second power control signal and the third power control signal, the control unit 119 controls the switch 510 so that the third adder 513 is connected to the fourth comparator 406. The control unit 119 performs controls so that the first and second registers 521 and 522 of the fifth bandpass filter 505 operate according to the second clock signal. The control unit 119 resets (clears to zero) the values being held by the first to fourth registers of the fifth bandpass filter 505. As a result, if the wave detection signal contains a 1.6-kHz component, the fifth bandpass filter 505 generates a fourth detection signal having amplitude that is increased in a cycle corresponding to 1.6 kHz. The fourth comparator 406 generates a stop signal if the fourth detection signal is larger than the fourth threshold value.

When receiving the stop signal, the control unit 119 judges that the signals received by the antenna 101 are not fourth signals and returns to a standby state instead of activating the communication circuit 108. More specifically, the control unit 119 performs controls so that the first and second registers 521 and 522 of the fifth bandpass filter 505 operate according to the clock signal. The control unit 119 resets (clears to zero) the values being held by the first to fourth registers of the fifth bandpass filter 505. As a result, the receiving circuit 620 comes to detect whether or not the signals received by the antenna 101 contain an 800-Hz component and a 3.2-kHz component.

On the other hand, if the control unit 119 has not received a stop signal even after a lapse of a prescribed time from reception of a second power control signal and a third power control signal, the control unit 119 judges that the signals received by the antenna 101 are fourth signals and controls the switch 110. The switch 110 connects the power unit 109 to the communication circuit 108 so that power is supplied to the communication circuit 108.

As described above, in the wireless communication system according to the embodiment, the same advantages as provided by the fourth embodiment are provided. Furthermore, since the first and second registers 521 and 522 of the fifth bandpass filter 505 operate according to the clock signal or the second clock signal whose rate is two times the rate of the clock signal, the single circuit can generate a second detection signal having amplitude that is increased at 3.2 kHz and a fourth detection signal having amplitude that is increased at 1.6 kHz. The circuit scale can thus be reduced.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A radio apparatus configured to communicate with a second radio apparatus after receiving plural first signals transmitted from the second radio apparatus in a constant cycle, the radio apparatus comprising:
a communication circuit configured to communicate with the second radio apparatus;
a wave detection circuit configured to generate a wave detection signal by envelope-detecting the plural first signals;
a bandpass filter having an IIR filter, configured to generate a detection signal form the wave detection signal, the detection signal having amplitude that is increased at a frequency corresponding to the constant cycle; and
a control unit configured to cause supply of power to the communication circuit if the amplitude is larger than a first threshold value.

2. A radio apparatus configured to communicate with a second radio apparatus which sends out a third signal repeatedly in a constant cycle after reception of the third signal, the third signal containing a first signal and a second signal which is sent so as to have a constant interval from the first signal, the radio apparatus comprising:
a communication circuit configured to communicate with the second radio apparatus;
a wave detection circuit configured to generate a wave detection signal by envelope-detecting the plural first signals;
a second-order IIR filter configured to generate a first detection signal from the wave detection signal, the first detection signal having amplitude that is increased at the constant intervals;
a second second-order IIR filter configured to generate a second detection signal from the wave detection signal, the second detection signal having amplitude that is increased in the constant cycle; and
a control unit configured to cause supply of power to the communication circuit if the amplitude of the first detection signal is larger than the first threshold value and the amplitude of the second detection signal is larger than a second threshold value.

3. The radio apparatus according to claim 2, further comprising
a third second-order IIR filter configured to generate a fourth detection signal from the wave detection signal, the fourth detection signal having amplitude that is increased in a cycle that is an integer times the constant cycle, wherein:
the control unit causes supply of power to the communication circuit if the amplitude of the first detection signal is larger than the first threshold value and the amplitude of the fourth detection signal is smaller than a third threshold value.

4. A radio apparatus configured to communicate with a second radio apparatus which sends out a third signal repeatedly in a constant cycle after reception of the third signal, the third signal containing a first signal and a second signal which is sent so as to have a constant interval from the first signal, the radio apparatus comprising:
a communication circuit configured to communicate with the second radio apparatus;
a wave detection circuit configured to generate a wave detection signal by envelope-detecting the plural first signals;
a fourth-order IIR filter configured to generate a first detection signal and a second detection signal from the wave detection signal, the first detection signal having amplitude that is increased at the constant intervals, and the second detection signal having amplitude that is increased at the constant intervals and in the constant cycle; and
a control unit configured to cause supply of power to the communication circuit if the amplitude of the first detection signal is larger than the first threshold value and the amplitude of the second detection signal is larger than the second threshold value.

5. The radio apparatus according to claim 4, wherein:
the fourth-order IIR filter generates a fourth detection signal from the first detection signal, the fourth detection signal having amplitude that is increased in a cycle that is an integer times the constant cycle when the fourth-order IIR filter operates according to a clock signal whose rate is two times a rate of a clock signal according to which the fourth-order IIR filter operates in generating the first detection signal and the second detection signal; and
the control unit causes supply of power to the communication circuit if the amplitude of the first detection signal is larger than the first threshold value and the amplitude of the fourth detection signal is smaller than the third threshold value.
